(19) United States
(12) Patent Application Publication
(10) Pub. No.: US 2017/0036336 A1
(43) Pub. Date: Feb. 9, 2017

(54) HAMMER ASSEMBLY

(71) Applicant: Caterpillar Inc., Peoria, IL (US)

(72) Inventor: Cody T. Moore, Waco, TX (US)

(73) Assignee: Caterpillar Inc., Peoria, IL (US)

(21) Appl. No.: 15/333,537

(22) Filed: Oct. 25, 2016

(51) Int. Cl. B25D 17/08; B25D 9/00

(52) U.S. Cl. CPC B25D 17/08; B25D 9/00; B25D 2250/051; B25D 2250/105

(57) ABSTRACT

A hammer assembly used in a machine is described. The hammer assembly comprises a power member, a tool member, and a housing member. The housing member includes a first set of channels and a second set of channels. The first set of channels is disposed along a first axis and the second set of channels is disposed along a second axis in an orthogonal direction with respect to the first axis. The hammer assembly is rotated by an angle to make use of any one of the first set of channels or the second set of channels. The first set of channels is shaped to receive a first set of pins and the second set of channels is shaped to receive a second set of pins for engagement of the housing member and the tool member.

### TECHNICAL FIELD

The present disclosure relates to hammer assemblies, and more specifically, to an improved hammer assembly used in a machine.

### BACKGROUND

A variety of machines are used for performing various material breaking operations. Such machines employ a hammer assembly for breaking large and hard objects, such as stones, rocks, concretes, among others. The hammer assembly generally includes a housing, a tool, and other sub-components that facilitate the operation of the tool. The housing protects the tool and a power member during operation of the machine. The hydraulic system utilizes a high pressure fluid that is supplied to the hammer assembly to drive a reciprocating piston that actuates the tool.

Conventionally, there are various mechanisms for supporting the tool inside the housing. For example, the tool may be guided using a lock groove based retention mechanism that uses specific shaped pins, for example oval shaped pins. However, sometimes the oval shaped pins may not be available depending upon worldwide regional deployment of the machines. During a. periodic maintenance, it may be challenging for operators to use the specific shaped pins since the oval shaped pins may be available in limited countries only. As a result, the operators may need to import such pins from other countries, increasing a downtime of the machine. Moreover, the oval shaped pins may be expensive to manufacture and/or procure.

Korean Publication Number 101141539 describes a chisel fixing device. The chisel fixing device includes a main body, a chisel, a chisel pin, a stop pin, a bush member, a fixing pin, and a piston. The piston is installed in the main body and the stop pin fixes the chisel to the main body. The bush member is coupled between the main body and the chisel to guide the chisel. The bush member is attached to the main body using the fixing pin and guides the chisel. The chisel pin includes an outer member having elasticity and an inner member. The inner member is embedded inside the outer member.

### SUMMARY OF THE DISCLOSURE

In one aspect of the present disclosure, a hammer assembly used in a machine is provided. The hammer assembly includes a power member adapted to operate a tool member and a housing member for enclosing the power member and the tool member. The housing member includes a first set of channels and a second set of channels. The first set of channels is disposed along a first axis of the housing member. The second set of channels is disposed along a second axis in an orthogonal direction with respect to the first axis of the housing member. The second set of channels intersects with at least a portion of the first set of channels. The hammer assembly is adapted to be rotated by an angle to make use of any one of the first set of Channels or the second set of channels. The first set of channels is shaped to receive a first set of pins and the second set of channels is shaped to receive a second set of pins for engagement of the housing member and the tool member, such that the first set of channels has an oval cross-section and the second set of channels has a circular cross-section.

Other features and aspects of this disclosure will be apparent from the following description and the accompanying drawings.

### BRIEF DESCRIPTION OF THE DRAWINGS

FIG. 1 is a side view of an exemplary machine utilizing a hammer assembly, in accordance with the concepts of the present disclosure;

FIG. 2 is a perspective view of the hammer assembly having a housing member, in accordance with the concepts of the present disclosure;

FIG. 3 is a perspective view of the housing member using a first set of pins in a first configuration, in accordance with the concepts of the present disclosure;

FIG. 4 is a perspective view of the housing member using a second set of pins in a second configuration, in accordance with the concepts of the present disclosure; and

FIG. 5 depicts a sectional view of the housing member along a plane 4-4′ of FIG. 4 showing a first set of channels and a second set of channels, in accordance with the concepts of the present disclosure.

### DETAILED DESCRIPTION

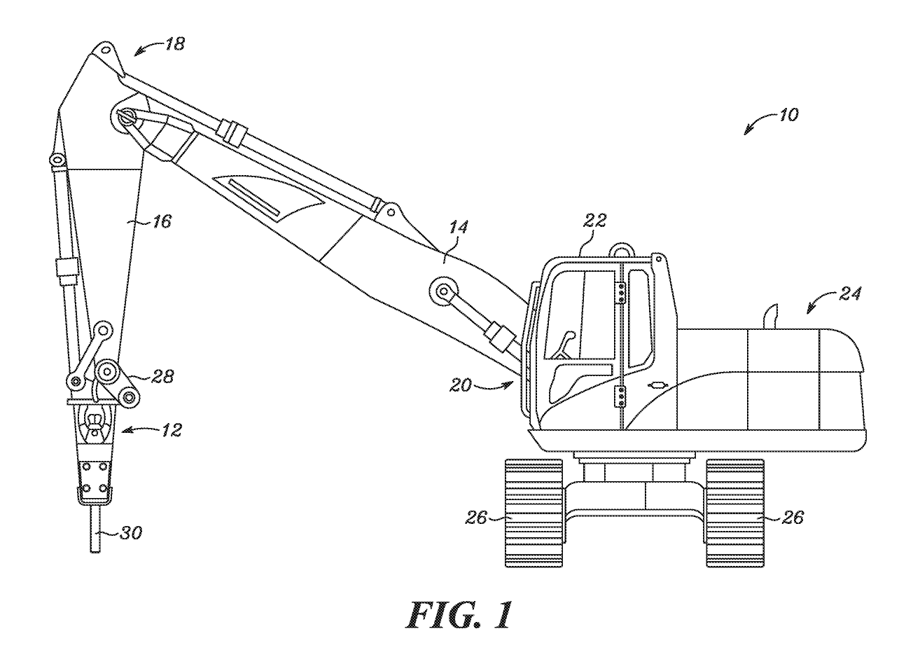

Referring to FIG. 1, an exemplary machine 10 is illustrated. In an embodiment, the machine 10 is a tracked excavator 10. The machine 10 utilizes a hammer assembly 12 for performing various operations, such as breaking of large and hard objects, i.e., stones, rocks, concretes, among others. The machine 10 includes a coupling mechanism 18. The coupling mechanism 18 includes a boom 14 and a stick 16. The boom 14 is attached to a frame 20 of the machine 10 for allowing adjustments in a height. The coupling mechanism 18 may allow articulate movements relative to the frame 20. The stick 16 is attached to the boom 14 via a mechanical joint (not shown). The boom 14 and the stick 16 are used to adjust a position and orientation of the hammer assembly 12 to perform a task as desired by an operator. For example, if the boom 14 is located on a right side or left side of an operator cabin 22, the position of the hammer assembly 12 changes appropriately. Similarly, the stick 16 may also be operated to change the position of the hammer assembly 12 as desired by the operator.

Further, the machine 10 includes an engine 24 and a number of tracks 26 for maneuvering the machine 10. The engine 24 provides a power for operating the machine 10. The operator utilizes a set of controls, such as joysticks, or other input modules (not shown) inside the operator cabin 22 for operating the hammer assembly 12. The hammer assembly 12 may be articulated in a suitable manner and orientation by the operator as per requirements. Further, a pivoting bracket 28 is used for pivoting the hammer assembly 12 relative to the boom 14. The pivoting bracket 28 may be hydraulically actuated. The coupling mechanism 18 may be complex, for example, including three or more degrees of freedom.

The hammer assembly 12 includes a tool member 30 for breaking the rocks, penetrating ground surfaces, among others. The hammer assembly 12 is operated by hydraulic systems not shown) that may induce pressure against the ground surfaces. Further, the tool member 30 may be a type of a moil point, blunt breakers, or chisels without departing from the scope of the disclosure. The machine 10 further includes various other components such as, but not limited to, hydraulic pipes, an exhaust, other circuitries that are not labeled in FIG. 1 for the purpose of simplicity. It will be apparent to one skilled in the art that the machine 10 shown in FIG. 1 is the tracked excavator 10. However, the machine 10 may be any other machines utilizing the hammer assembly 12 such as, but not limited to, a backhoe, an excavator, a dozer, a loader, a motor grader, or any other earth moving machine, without departing from the scope of the disclosure.

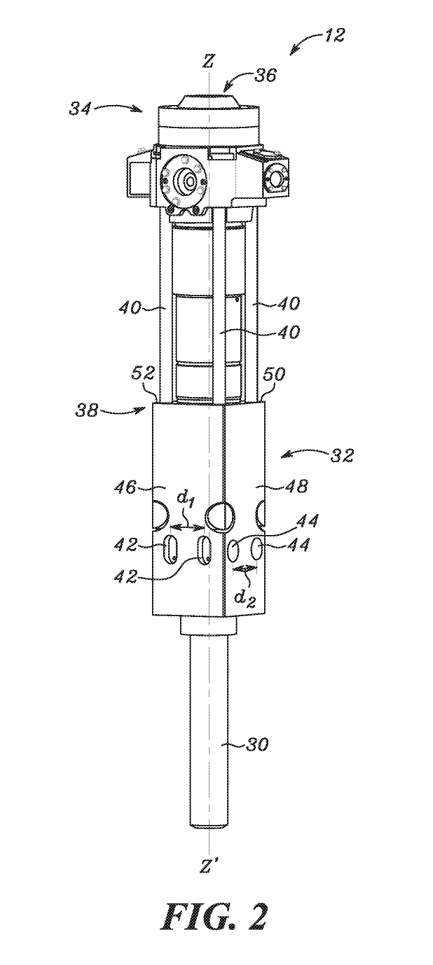

Referring to FIG. 2, the hammer assembly 12 includes the tool member 30, a housing member 32 and a power member 34. The power member 34 has a first end 36 and a second end 38. A power cell (not shown) at the first end 36 of the power member 34 is configured to receive a pressurized fluid that facilitates operations of the hammer assembly 12. The power member 34 is coupled to the tool member 30 at the second end 38. The power member 34 utilizes hydraulic energy from the pressurized fluid for operating the tool member 30. As a result, the tool member 30 is actuated for breaking the objects, or drilling holes. The power member 34 may also be pneumatically driven for operating the tool member 30, without departing from the scope of the disclosure. The housing member 32 is connected to the power member 34 via a number of studs 40. The housing member 32 is utilized for enclosing the power member 34 and the tool member 30.

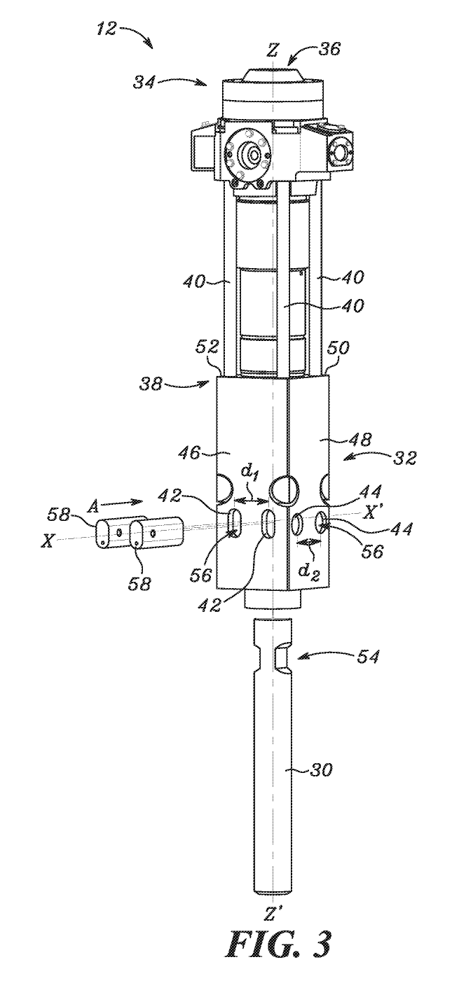

Referring to FIGS. 3, 4 and 5, the housing member 32 includes a first set of channels 42 and a second set of channels 44. The housing member 32 includes a first surface 46, a second surface 48, a third surface 50 and a fourth surface 52 to form an enclosure. The first surface 46 is adjacent to the second surface 48 and the fourth surface 52. The first surface 46 is opposite to the third surface 50. The third surface 50 is adjacent to the second surface 48 and the fourth surface 52. The first set of channels 42 is disposed between the first surface 46 and the third surface 50. The second set of channels 44 is disposed between the second surface 48 and the fourth surface 52.

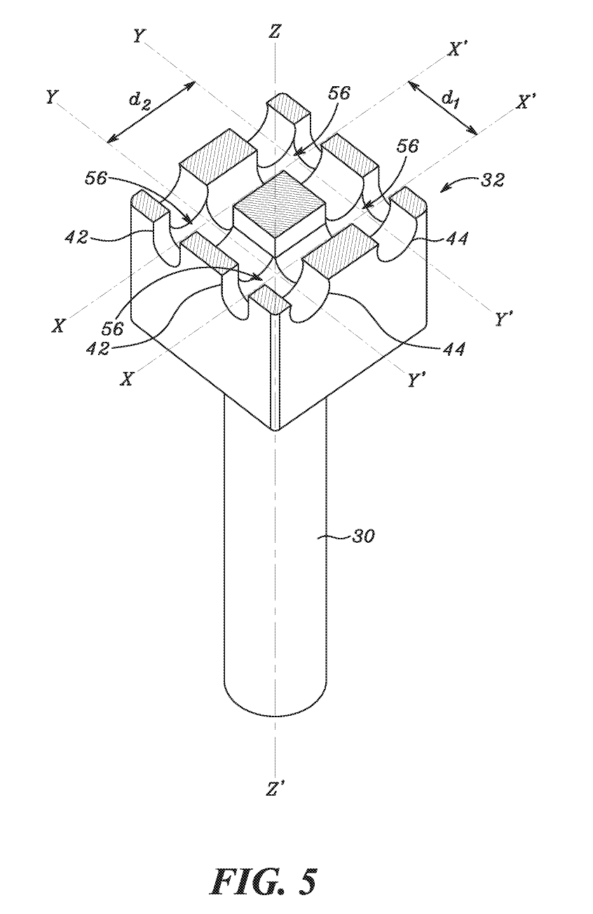

The first set of channels 42 is disposed along a first axis X-X′ of the housing member 32 (see FIG. 5). The first set of channels 42 is a through passage across the first surface 46 and the third surface 50. The second set of channels 44 is disposed along a second axis Y-Y′ (see FIG. 5). The second set of channels 44 is a through passage across the second surface 48 and the fourth surface 52. It will be apparent to one skilled in the art that the first set of channels 42 and the second set of channels 44 may also be interchangeably disposed across various surfaces of the housing member 32, without departing from the scope of the disclosure Further, the tool member 30 has a notch portion 54 for engaging the tool member 30.

The second axis Y-Y′ is in an orthogonal direction with respect to the first axis X-X′. The second set of channels 44 intersects with the first set of channels 42 across various regions 56 (see FIG. 5). In an embodiment, the second set of channels 44 is disposed centrally and symmetrically with respect to the first set of channels 42. The shapes of the first set of channels 42 and the second set of channels 44 are different with respect to each other. In an embodiment, the first set of channels 42 has an oval cross-section. In an embodiment, the second set of channels 44 has a circular cross-section. The first set of channels 42 includes two channels disposed longitudinally along the first axes X-X′. The two channels are parallel with respect to each other and are spaced apart from each other by a distance d₁. The second set of channels 44 includes two channels disposed laterally along the second axes Y-Y′. The two channels are parallel with respect to each other and are spaced apart from each other by a distance d₂. It will be apparent to one skilled in the art that the first set of channels 42 and the second set of channels 44 may have alternate cross-section, counts, or placement within the housing member 32, without departing from the scope of the disclosure.

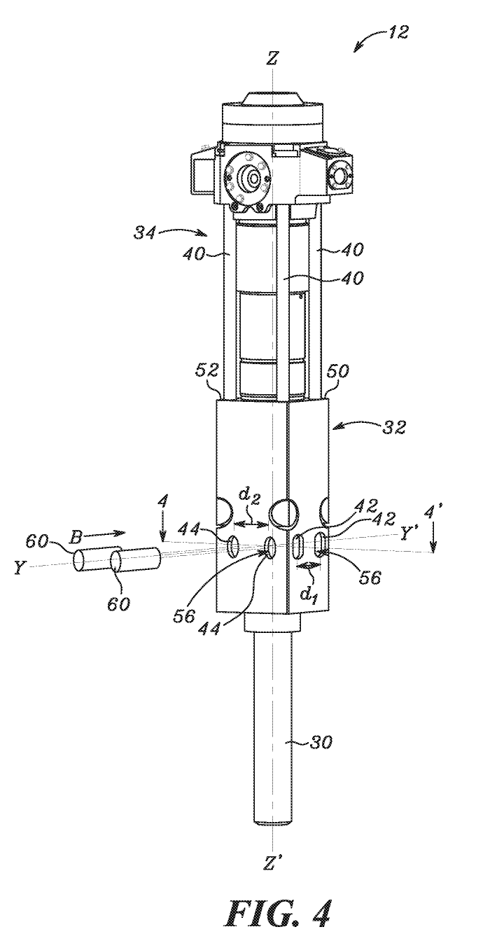

The hammer assembly 12 may be used either in a first configuration (see FIG. 3) or a second configuration (see FIG. 4). For example, in the first configuration, the housing member 32 uses only a first set of pins 58 across the first set of channels 42 (see FIG. 3), while in the second configuration, the housing member 32 uses only a second set of pins 60 across the second set of Channels 44 (see FIG. 4) as described in subsequent paragraphs. Accordingly, the tool member 30 can be connected to the housing member 32 of the hammer assembly 12 either by using the first set of pins 58 or the second set of pins 60 based on availability and need of the operator without requiring replacement of the hammer assembly 12.

Referring to FIGS. 3 and 5, in the first configuration, the first set of channels 42 is adapted to receive the first set of pins 58 along the first axis X-X′ as shown by a direction A. Since the first set of channels 42 and the second set of channels 44 are used one at a time, in this configuration, the second set of channels 44 is redundant. In an embodiment, the first set of pins 58 has an oval shape that corresponds to the oval cross-section of the first set of channels 42. The first set of pins 58 is retained within the notch portion 54 provided on the tool member 30. As a result, the first set of pins 58 passes through the notch portion 54 for engaging the tool member 30.

Referring to FIGS. 4 and 5, in the second configuration, the hammer assembly 12 is rotated by an angle to easily present the second set of channels 44 to the operator for use of the second set of channels 44 in engaging the tool member 30. In an embodiment, the hammer assembly 12 is rotated by about 90 degrees with respect to a vertical axis Z-Z′ to present the second set of channels 44 for use. In this configuration, the second set of channels 44 is adapted to receive the second set of pins 60 along the second axis Y-Y′ as shown by a direction B. Since the first set of Channels 42 and the second set of channels 44 are used one at a time, in this configuration, the first set of channels 42 is redundant. In an embodiment, the second set of pins 60 has a circular shape that corresponds to the circular cross-section of the second set of channels 44. The second set of pins 60 is retained within the notch portion 54 (see FIG. 3) provided on the tool member 30. As a result, the second set of pins 60 passes through the notch portion 54 for engaging the tool member 30.

It will be apparent to one skilled in the art that the first set of pins 58 and the second set of pins 60 may be made of hardened type steels or any other materials, without departing from the scope of the disclosure. Also, the first set of pins 58 and the second set of pins 60 may also have a different profile and cross-section depending on a design. It will be apparent to one skilled in the art that the present disclosure is not limited to any particular pressurized fluid system and that any suitable arrangement capable of driving upward and downward reciprocating movement to the tool member 30 may be used.

### INDUSTRIAL APPLICABILITY

The housing member 32 enhances operability of the hammer assembly 12 when deployed in different regions of world. The second set of channels 44 enhances utility of the hammer assembly 12 by allowing the same hammer assembly 12 to be used irrespective of whether circular shaped pins (i.e., the second set of pins 60) or oval shaped pins (i.e., the first set of pins 58) are available. In order to present different cross sectional options for usage of the differently shaped pins, the operator needs to disengage the tool member 30 from the housing member 32 if it is already connected thereto, rotate the housing member 32 to present any one of the first set of channels 42 or the second set of channels 44 and then re-engage the housing member 32 using the respective oval shaped pins (i.e., the first set of pins 58) or the circular shaped pins (i.e., the second set of pins 60). Thus, differently shaped pins may be easily used on the same hammer assembly 12, without requiring replacement, additional costs, and/or increased machine downtime.

Further, fabrication of the second set of channels 44 in the housing member 32 is easy and cost effective. The operator is flexible to use either the first set of pins 58 or the second set of pins 60 during a breakdown or a periodic maintenance. The operator may not need to import and wait for specific pins from other countries, thereby improving an overall efficiency of the hammer assembly 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hammer assembly used in a machine, the hammer assembly comprising:
a power member adapted to operate a tool member; and
a housing member for enclosing the power member and the tool member, the housing member including:
a first set of channels disposed along a first axis of the housing member; and
a second set of channels disposed along a second axis in an orthogonal direction with respect to the first axis of the housing member, such that the second set of channels intersects with at least a portion of the first set of channels,
wherein the hammer assembly is adapted to be rotated by an angle to make use of any one of the first set of channels or the second set of channels, and wherein the first set of channels is shaped to receive a first set of pins and the second set of channels is shaped to receive a second set of pins for engagement of the housing member and the tool member, such that the first set of channels has an oval cross-section and the second set of channels has a circular cross-section.
